(19) United States
(12) Patent Application Publication
(10) Pub. No.: US 2024/0104752 A1
(43) Pub. Date: Mar. 28, 2024

(54) IMAGE PROCESSING DEVICE, IMAGE PROCESSING METHOD, AND RECORDING MEDIUM

(71) Applicant: NEC Corporation, Minato-ku, Tokyo (JP)

(72) Inventor: Masahito Sakai, Tokyo (JP)

(73) Assignee: NEC Corporation, Minato-ku, Tokyo (JP)

(21) Appl. No.: 18/276,183

(22) PCT Filed: Nov. 24, 2021
(86) PCT No.: PCT/JP2021/042958

§ 371 Date: Aug. 7, 2023

(30) Foreign Application Priority Data
Feb. 25, 2021 (JP) 2021-028035

(51) Int. Cl. G06T 7/32; G06T 3/00

(52) U.S. Cl. CPC G06T 7/32; G06T 3/00

(57) ABSTRACT

In the present invention, master image data is used to improve precision for correcting target image data. A generation unit (11) performs an affine transformation on the target image data, thereby generating a transformation image group including a plurality of transformation image data; a calculation unit (12) calculates a correlation value between transformation image data included in the transformation image group, and preregistered master image data; a selection unit (13) selects the transformation image data having the greatest correlation value from among the transformation image data included in the transformation image group; and a correction unit (14) corrects the selected transformation image data on the basis of the positional displacement between an object shown in the master image data and the object shown in the selected transformation image data.

### TECHNICAL FIELD

The present invention relates to an image processing device, an image processing method, and a recording medium, and more particularly, to an image processing device, an image processing method, and a recording medium that correct image data acquired from an imaging device.

### BACKGROUND ART

A technique for correcting target image data using reference image data (referred to as master image data) registered in advance is known. An example of the technique is described in PTL 1.

In the related technique described in PTL 1, a two-dimensional barcode added to an analog meter is detected from image data obtained by imaging the analog meter. Then, the target image data is primarily corrected in such a way that the two-dimensional barcode in the target image data has the same size and the same shape as the two-dimensional barcode in the master image data.

Furthermore, in the related technique described in PTL 1, some regions including a specific pattern (for example, letters or numbers) drawn on the board face of the analog meter are cut out from the primarily corrected image data. Subsequently, the positional deviation of the region cut out from the primarily corrected image data with respect to the related region of the master image data is calculated using the phase-only correlation method. Thereafter, the image data is secondarily corrected based on the calculated positional deviation.

### CITATION LIST

### Patent Literature

PTL 1: WO 2020/175566 A1
PTL 2: JP 2020-166587 A

### SUMMARY OF INVENTION

### Technical Problem

It is assumed that master image data obtained by imaging an object such as an analog meter from the front is registered in advance. When a user captures an image of the same object with the imaging device held in the hand, the imaging direction may be inclined with respect to the front of the object. In this case, a deviation in the position, size, and shape of the object occurs between the object appearing in the target image data and the object appearing in the master image data registered in advance. As a result, there is a possibility that the target image data cannot be accurately corrected based on the master image data.

The present invention has been made in view of the above problems, and an object of the present invention is to improve accuracy of correcting target image data using master image data.

### Solution to Problem

An image processing device according to an aspect of the present invention includes a generation means for generating a transformed image group including a plurality of pieces of transformed image data by performing affine transformation on target image data, a calculation means for calculating a correlation value between the transformed image data included in the transformed image group and master image data registered in advance, a selection means for selecting transformed image data having the correlation value being maximum from among the transformed image data included in the transformed image group, and a correction means for correcting the selected transformed image data based on a positional deviation between an object appearing in the master image data and an object appearing in the selected transformed image data.

An image processing method according to an aspect of the present invention includes generating a transformed image group including a plurality of pieces of transformed image data by performing affine transformation on target image data, calculating a correlation value between the transformed image data included in the transformed image group and master image data registered in advance, selecting transformed image data having the correlation value being maximum from among the transformed image data included in the transformed image group, and correcting the selected transformed image data based on a positional deviation between an object appearing in the master image data and an object appearing in the selected transformed image data.

A recording medium according to an aspect of the present invention stores a program for causing a computer to execute a step of generating a transformed image group including a plurality of pieces of transformed image data by performing affine transformation on target image data, a step of calculating a correlation value between the transformed image data included in the transformed image group and master image data registered in advance, a step of selecting transformed image data having the correlation value being maximum from among the transformed image data included in the transformed image group, and a step of correcting the selected transformed image data based on a positional deviation between an object appearing in the master image data and an object appearing in the selected transformed image data.

### Advantageous Effects of Invention

According to an aspect of the present invention, accuracy of correcting target image data using master image data can be improved.

### BRIEF DESCRIPTION OF DRAWINGS

FIG. 1 is a diagram schematically illustrating imaging of an object (analog meter) by an imaging device and transmission of image data from the imaging device to an image processing device according to any of the first to third example embodiments.

FIG. 2 is a block diagram illustrating a configuration of an image processing device according to the first example embodiment.

FIG. 3 is a flowchart illustrating an operation of the image processing device according to the first example embodiment.

FIG. 4 is a diagram illustrating an example of a flow of an operation of the image processing device according to the first example embodiment.

FIG. 5 is a block diagram illustrating a configuration of an image processing device according to the second example embodiment.

FIG. 6 is a flowchart illustrating an operation of the image processing device according to the second example embodiment.

FIG. 7 is a block diagram illustrating a configuration of an image processing device according to the third example embodiment.

FIG. 8 is a flowchart illustrating an operation of an image processing device according to the third example embodiment.

FIG. 9 is a diagram illustrating an example of a hardware configuration of the image processing device according to the first to third example embodiments.

### EXAMPLE EMBODIMENT

### Common to All Example Embodiments

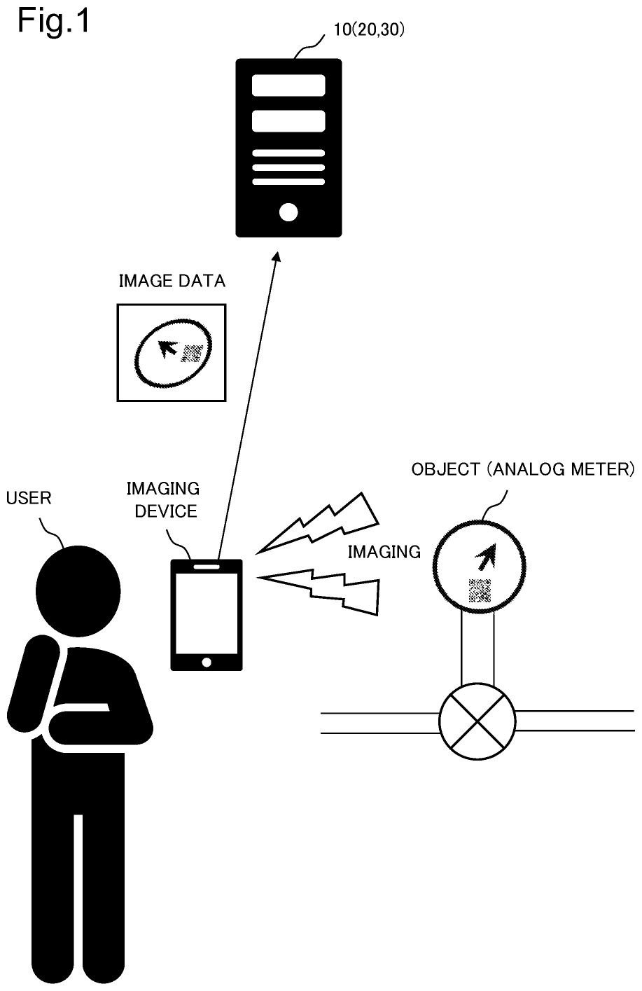

FIG. 1 illustrates a state in which a user holds an imaging device and captures an image of a target object (FIG. 1 illustrates an analog meter as an example.). In FIG. 1, image data of a target captured by an imaging device is transmitted from the imaging device to any one of the image processing devices 10, 20, and 30 according to any of the first to third example embodiments. Hereinafter, “any of the image processing devices 10, 20, and 30” is referred to as an “image processing device 10 (20, 30)”. Hereinafter, the image data transmitted from the imaging device to the image processing device 10 (20, 30) is referred to as “target image data”. The target image data is obtained by imaging an object (an analog meter in FIG. 1).

As illustrated in FIG. 1, the imaging device is an information device possessed by a user. For example, the imaging device is a smartphone or a tablet terminal. The imaging device is connected to the image processing device 10 (20, 30) by wireless communication such as Wi-Fi (registered trademark) or Bluetooth (registered trademark).

An application for remotely operating the image processing device (20, 30) is installed in the imaging device. The user inputs an instruction to the image processing device 10 (20, 30) into a user interface (UI) of an application, so that an instruction command is transmitted from the imaging device to the image processing device 10 (20, 30). As a result, the user can remotely operate the image processing device 10 (20, 30) using the imaging device.

In a modification, the imaging device and the image processing device 10 (20, 30) may be integrated. In other words, the processing performed by the image processing device 10 (20, 30) to be described later may be implemented as part of the information processing function of the imaging device.

An object (an analog meter in FIG. 1) is imaged by an imaging device. The type of the object is not particularly limited, but examples other than the analog meter include a poster, a calendar, a spine of a book, or the like in which characters and symbols are disposed. Alternatively, another example is an object through which scenery is seen, such as monitors and windows. However, the type of the object is not limited to the above example.

### First Example Embodiment

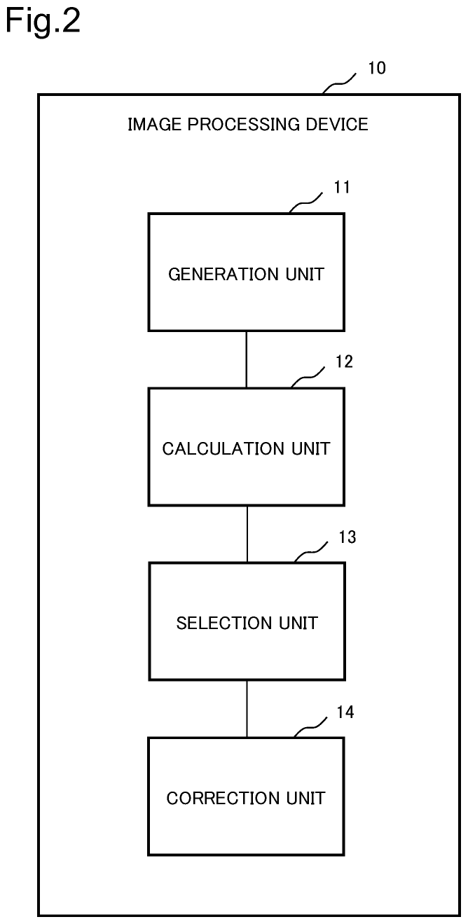

The first example embodiment will be described with reference to FIGS. 2 to 4.

(Image Processing Device 10)

FIG. 2 is a block diagram illustrating a configuration of an image processing device 10 according to the present first example embodiment. As illustrated in FIG. 2, the image processing device 10 includes a generation unit 11, a calculation unit 12, a selection unit 13, and a correction unit 14.

The generation unit 11 generates a transformed image group including a plurality of pieces of transformed image data by performing affine transformation on the target image data. The generation unit 11 is an example of a generation means.

In an example, the generation unit 11 acquires target image data from the imaging device (FIG. 1). The target image data is obtained by imaging an object (an analog meter in FIG. 1), that is, the analog meter appears in the image data. The generation unit 11 performs a single affine transformation on the target image data to perform a 3×3 matrix operation on the coordinates of the target image data, thereby transforming the coordinates of the target image data into the coordinates of the destination data, and obtaining one piece of transformed image data. The affine transformation is a combination of a linear transformation (i.e., matrix operation) and a translation.

Alternatively, the generation unit 11 may obtain a plurality of pieces of image data from the target image data. In this case, the generation unit 11 generates a plurality of pieces of transformed image data by performing different affine transformations on the acquired target image data.

Specifically, the generation unit 11 generates a predetermined number of pieces of transformed image data from the target image data by a mapping (different affine transformations) combining enlargement, reduction, rotation, and translation of the image. The generation unit 11 outputs the transformed image group including the plurality of pieces of transformed image data generated in this manner to the calculation unit 12.

The calculation unit 12 calculates a correlation value between the transformed image data included in the transformed image group and the master image data registered in advance. The calculation unit 12 is an example of a calculation means.

In an example, the calculation unit 12 calculates a correlation value between the transformed image data and the master image data by using a phase-only correlation method. In another example, the calculation unit 12 calculates a correlation coefficient (which is an example of a correlation value) between the pixel value of the transformed image data and the pixel value of the master image data by using an any method using the hue, the luminance value, and/or the pattern as parameters. Specifically, the calculation unit 12 can use a sum of absolute difference (SAD), a sum of squared difference (SSD), or a normalized cross-correlation (NCC).

As described above, the calculation unit 12 calculates a correlation value between each transformed image data included in the transformed image group and the master image data registered in advance. Then, the calculation unit 12 calculates correlation values for all the transformed image data included in the transformed image group, and then outputs data of correlation values associated with the related transformed image data to the selection unit 13.

The selection unit 13 selects the transformed image data having the maximum correlation value from the transformed image data included in the transformed image group. The selection unit 13 is an example of a selection means.

In an example, the selection unit 13 receives data of correlation values calculated for all the transformed image data included in the transformed image group from the calculation unit 12. The selection unit 13 selects one piece of transformed image data from all the pieces of transformed image data included in the transformed image group based on the magnitude relationship between the correlation values.

Specifically, the selection unit 13 selects the transformed image data having the largest correlation value with the master image data from among all the transformed image data included in the transformed image group. The selection unit 13 outputs the selected transformed image data to the correction unit 14.

The correction unit 14 corrects the selected transformed image data based on the positional deviation between the object (analog meter in FIG. 1) appearing in the master image data and the object appearing in the selected transformed image data. The correction unit 14 is an example of a correction means.

In an example, the correction unit 14 receives the selected transformed image data from the selection unit 13. The correction unit 14 calculates a projective transformation (geometric transformation) matrix between the selected transformed image data and the master image data. Then, the correction unit 14 transforms the coordinate system of the selected transformed image data into the coordinate system of the master image data using the projective transformation matrix.

By the calculation using the projective transformation matrix, the selected transformed image data is corrected in such a way that the shape and size of the meter appearing in the selected transformed image data approach those of the meter included in the master image data.

(Operation of Image Processing Device 10)

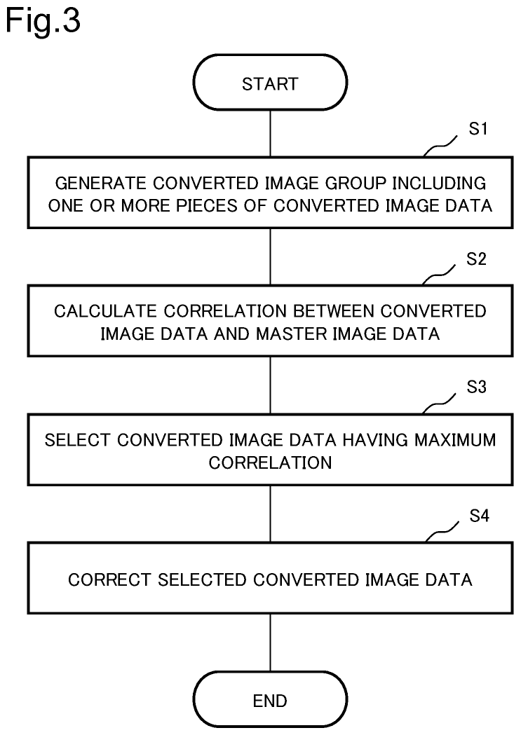

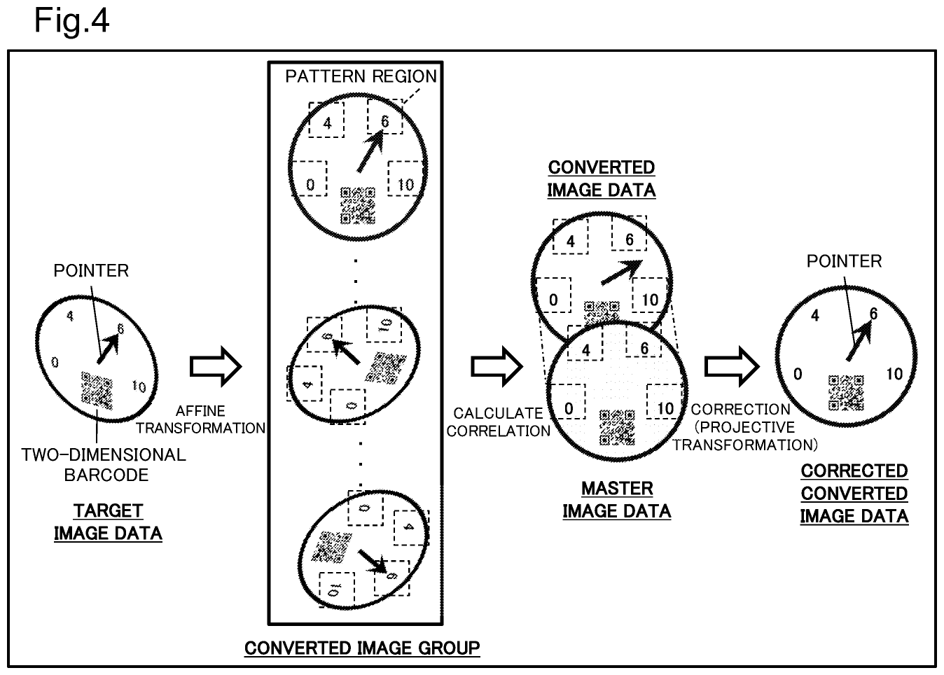

The operation of the image processing device 10 according to the present first example embodiment will be described with reference to FIGS. 3 and 4. FIG. 3 is a flowchart illustrating a flow of processing performed by each unit of the image processing device 10. FIG. 4 is a diagram illustrating an example of the operation of the image processing device 10.

As illustrated in FIG. 4, first, the generation unit 11 of the image processing device 10 acquires target image data obtained by imaging an object (for example, an analog meter). A pointer, a number, and a two-dimensional barcode are disposed on a front face (board face) of the analog meter. Hereinafter, the correction of the image data of the analog meter will be described.

As illustrated in FIG. 3, first, the generation unit 11 generates a transformed image group including a plurality of pieces of transformed image data by performing affine transformation on the image data of the analog meter (S1). In FIG. 4, a transformed image group including three pieces of transformed image data are illustrated as an example. In an example, the generation unit 11 obtains these three pieces of transformed image data by performing different affine transformations on a specific pattern region in the image data of the analog meter. The generation unit 11 may detect the pattern region in the transformed image data using a method such as a sliding window method. As illustrated in FIG. 4, the pattern region may be a region including a specific character or a specific number.

Next, the calculation unit 12 calculates a correlation value between the transformed image data included in the transformed image group and the master image data registered in advance (S2).

Subsequently, the selection unit 13 selects the transformed image data having the maximum correlation value from the transformed image data included in the transformed image group (S3).

Thereafter, the correction unit 14 corrects the selected transformed image data based on the positional deviation between the object appearing in the master image data and the object appearing in the selected transformed image data (S4).

As described above, the operation of the image processing device according to the present first example embodiment ends.

### Modifications

In a modification, after step S4, the corrected transformed image data may be transmitted from the image processing device 10 to a pointer reading device (not illustrated). The pointer reading device reads a numerical value indicated by a pointer (FIG. 4) of the analog meter in the corrected transformed image data by a known image recognition technique. In another modification, the image processing device 10 further includes a pointer reading unit. In this case, the pointer reading unit of the image processing device 10 reads the numerical value indicated by the pointer of the analog meter from the corrected transformed image data (the second example embodiment).

### Effects of Present Example Embodiment

According to the configuration of the present example embodiment, the generation unit 11 generates a transformed image group including a plurality of pieces of transformed image data by performing affine transformation on target image data. The calculation unit 12 calculates a correlation value between the transformed image data included in the transformed image group and the master image data registered in advance. The selection unit 13 selects the transformed image data having the maximum correlation value from the transformed image data included in the transformed image group. The correction unit 14 corrects the selected transformed image data based on the positional deviation between the object appearing in the master image data and the object appearing in the selected transformed image data.

In this manner, one piece of the transformed image data is selected from the transformed image group generated from the target image data based on the magnitude of the correlation with the master image data. The transformed image data having the largest correlation value with the master image data is closest to the master image data in terms of the angle of the imaging device with respect to the meter and the distance from the imaging device to the meter. By selecting the transformed image data having a high correlation value with the master image data, the accuracy of correcting the target image data using the master image data can be improved.

### Second Example Embodiment

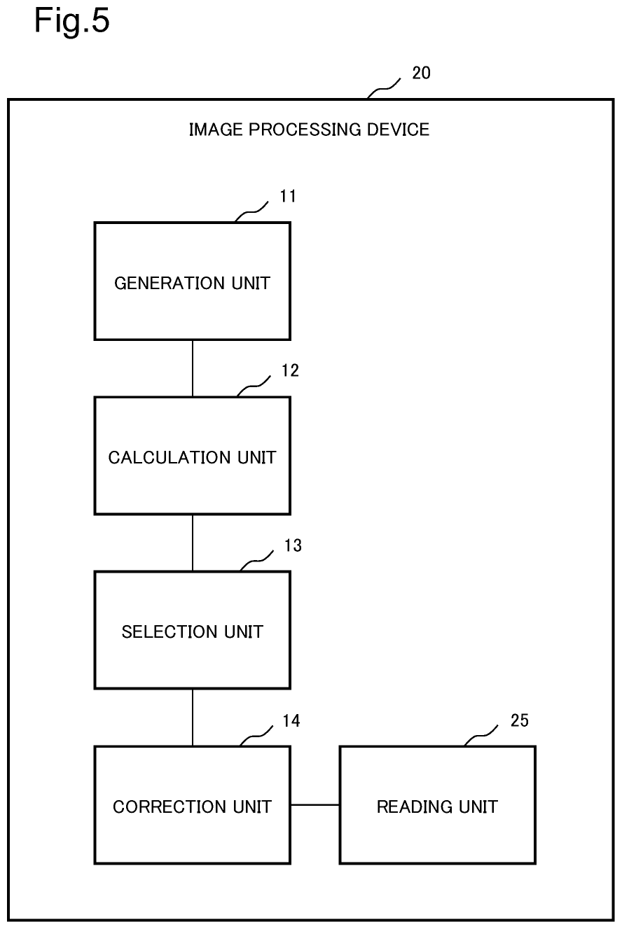

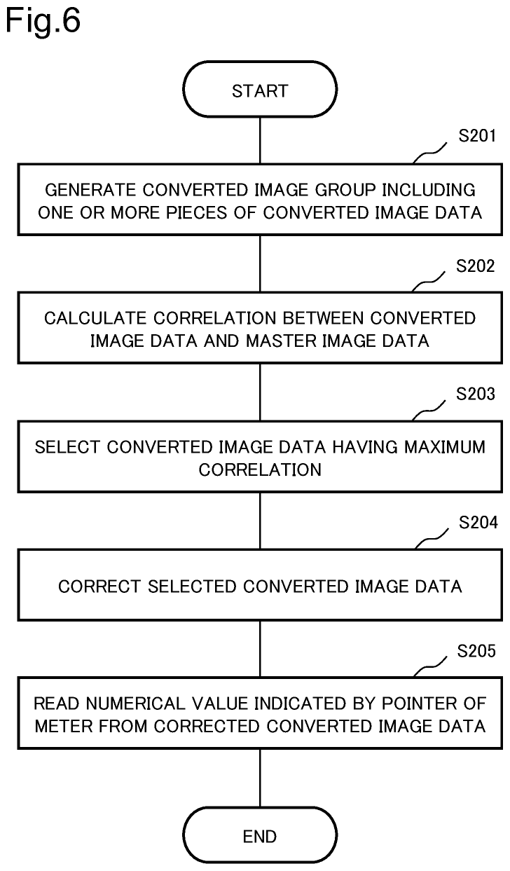

The second example embodiment will be described with reference to FIGS. 5 to 6. In the present second example embodiment, the same reference numerals as those in the first example embodiment are used for members common to those in the first example embodiment, and the description thereof will be omitted.

(Image Processing Device 20)

FIG. 5 is a block diagram illustrating a configuration of an image processing device 20 according to the present second example embodiment. As illustrated in FIG. 5, the image processing device 20 includes the generation unit 11, the calculation unit 12, the selection unit 13, and the correction unit 14. The image processing device 20 further includes a reading unit 25.

The reading unit 25 reads a numerical value indicated by the pointer of the meter from the corrected transformed image data. The reading unit 25 is an example of a reading means.

In an example, the reading unit 25 receives the corrected transformed image data from the correction unit 14. The reading unit 25 may read a numerical value indicated by a pointer of the meter from the corrected transformed image data by optical character recognition (OCR), or may use an estimator that is machine trained. Alternatively, the reading unit 25 may use an image recognition technique described in PTL 2.

The reading unit 25 may transmit information indicating a numerical value indicated by a pointer of the meter to a processing unit (not illustrated) in a subsequent stage or an external device (not illustrated). For example, the reading unit 25 displays the numerical value indicated by the pointer of the meter on the screen of the imaging device (FIG. 1). Alternatively, the reading unit 25 may record information indicating a numerical value indicated by the pointer of the meter in an external storage device.

(Operation of Image Processing Device 20)

The operation of the image processing device 20 according to the present second example embodiment will be described with reference to FIG. 6. FIG. 6 is a flowchart illustrating a flow of processing performed by each unit of the image processing device 20. FIG. 6 is a diagram illustrating an example of the operation of the image processing device 20.

As illustrated in FIG. 6, first, the generation unit 11 generates a transformed image group including a plurality of pieces of transformed image data by performing affine transformation on the image data of the analog meter (S201). At this time, the generation unit 11 may calculate a correlation value between a specific pattern region (FIG. 4) in the transformed image data and a related pattern region in the master image data by using, for example, a phase-only correlation method.

Next, the calculation unit 12 calculates a correlation value between the transformed image data included in the transformed image group and the master image data registered in advance (S202).

Subsequently, the selection unit 13 selects the transformed image data having the maximum correlation value from the transformed image data included in the transformed image group (S203).

Thereafter, the correction unit 14 corrects the selected transformed image data based on the positional deviation between the object appearing in the master image data and the object appearing in the selected transformed image data (S204).

A numerical value indicated by the pointer of the meter is read from the corrected transformed image data (S205).

As described above, the operation of the image processing device according to the present second example embodiment ends.

### Effects of Present Example Embodiment

According to the configuration of the present example embodiment, the generation unit 11 generates a transformed image group including a plurality of pieces of transformed image data by performing affine transformation on target image data. The calculation unit 12 calculates a correlation value between the transformed image data included in the transformed image group and the master image data registered in advance. The selection unit 13 selects the transformed image data having the maximum correlation value from the transformed image data included in the transformed image group. The correction unit 14 corrects the selected transformed image data based on the positional deviation between the object appearing in the master image data and the object appearing in the selected transformed image data.

In this manner, one piece of the transformed image data is selected from the transformed image group generated from the target image data based on the magnitude of the correlation with the master image data. The transformed image data having the largest correlation value with the master image data is closest to the master image data in terms of the angle of the imaging device with respect to the meter and the distance from the imaging device to the meter. By selecting the transformed image data having a high correlation value with the master image data, the accuracy of correcting the target image data using the master image data can be improved.

Furthermore, according to the configuration of the present example embodiment, the reading unit 25 reads the numerical value indicated by the pointer of the meter from the corrected transformed image data. As a result, it is possible to reduce the work load of the user related to the management of the meter and to reduce the work cost.

### Third Example Embodiment

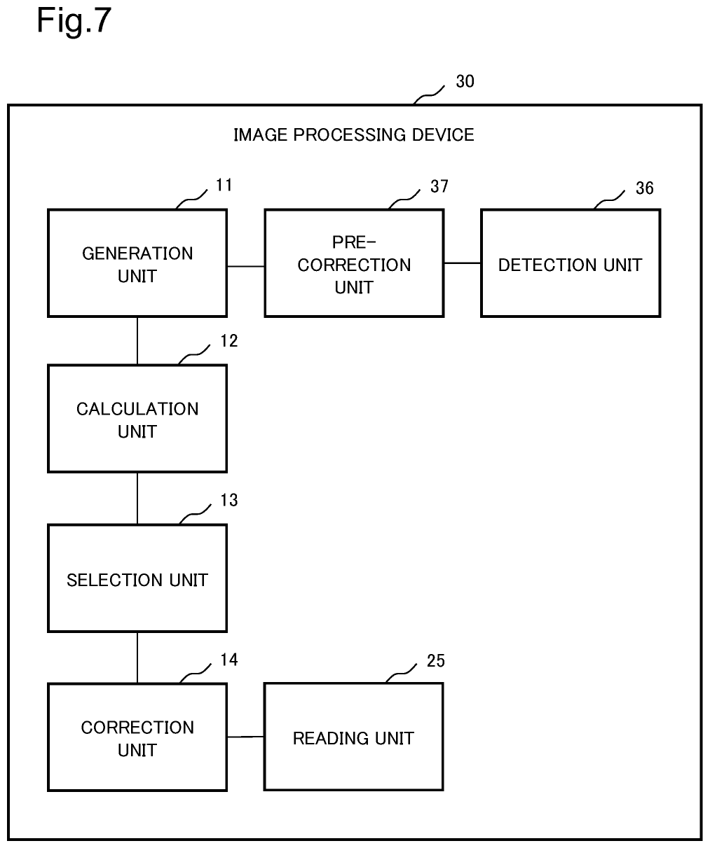

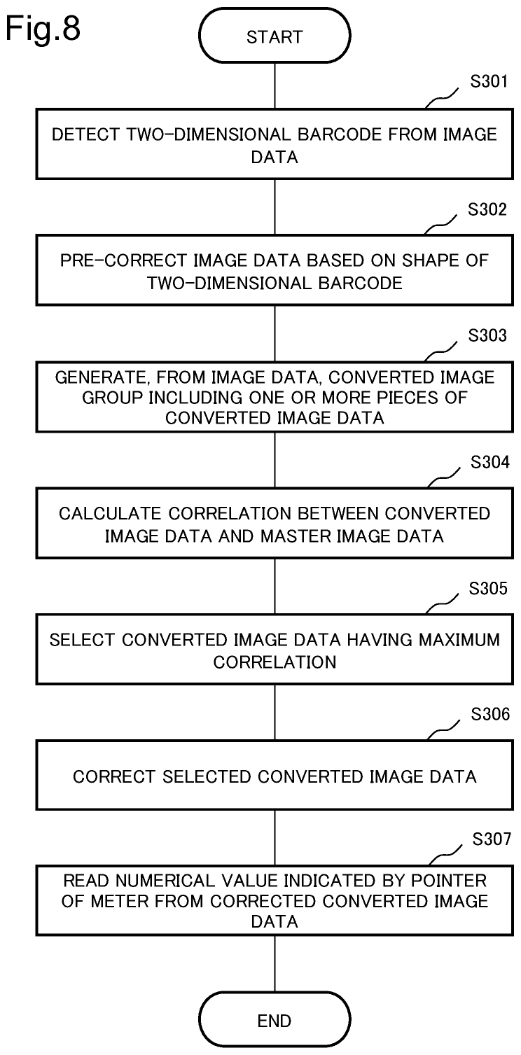

The third example embodiment will be described with reference to FIGS. 7 to 8. In the third present example embodiment, the same reference numerals as in the first or second example embodiment are used for members common to the first or second example embodiment, and the description thereof will be omitted.

(Image Processing Device 30)

FIG. 7 is a block diagram illustrating a configuration of an image processing device 30 according to the third present example embodiment. As illustrated in FIG. 7, the image processing device 30 includes the generation unit 11, the calculation unit 12, the selection unit 13, and the correction unit 14. The image processing device 30 further includes the reading unit 25, a detection unit 36, and a pre-correction unit 37.

The detection unit 36 detects a two-dimensional barcode (FIG. 4) from target image data. The detection unit 36 is an example of a detection means.

In an example, the detection unit 36 receives target image data from the imaging device (FIG. 1). The detection unit 36 detects a two-dimensional barcode from target image data using an image analysis technique such as pattern detection. The detection unit 36 outputs, to the pre-correction unit 37, information indicating the region of the two-dimensional barcode detected from the target image data together with the target image data.

The information indicating the region of the two-dimensional barcode is positional coordinates of the region occupied by the two-dimensional barcode in the target image data.

The pre-correction unit 37 pre-corrects the target image data by affine transformation or homography transformation based on the two-dimensional shape of the two-dimensional barcode. The pre-correction unit 37 is an example of a pre-correction means.

In an example, the pre-correction unit 37 receives, from the detection unit 36, information indicating the region of the two-dimensional barcode detected from the target image data. The pre-correction unit 37 corrects the target image data using the information indicating the region of the two-dimensional barcode.

Specifically, the pre-correction unit 37 performs projective transformation of the target image data in such a way that the positional coordinates of the two-dimensional barcode in the master image data are related to the positional coordinates of the two-dimensional barcode in the target image data. The pre-correction unit 37 outputs the target image data corrected in this manner to the generation unit 11.

In the third present example embodiment, the generation unit 11 generates a transformed image group including a plurality of pieces of transformed image data by performing affine transformation on the target image data corrected by the pre-correction unit 37.

(Operation of Image Processing Device 30)

The operation of the image processing device 30 according to the third present example embodiment will be described with reference to FIG. 7. FIG. 7 is a flowchart illustrating a flow of processing performed by each unit of the image processing device 30. FIG. 7 is a diagram illustrating an example of the operation of the image processing device 30.

As illustrated in FIG. 7, the detection unit 36 detects a two-dimensional barcode from target image data (S301).

The pre-correction unit 37 pre-corrects the target image data by affine transformation or homography transformation based on the two-dimensional shape of the two-dimensional barcode (S302).

The generation unit 11 generates a transformed image group including a plurality of pieces of transformed image data by performing affine transformation on the image data of the analog meter (S303). At this time, the generation unit 11 may calculate a correlation value between a specific pattern region (FIG. 4) in the transformed image data and a related pattern region in the master image data by using, for example, a phase-only correlation method.

Next, the calculation unit 12 calculates a correlation value between the transformed image data included in the transformed image group and the master image data registered in advance (S304).

Subsequently, the selection unit 13 selects the transformed image data having the maximum correlation value from the transformed image data included in the transformed image group (S305).

Thereafter, the correction unit 14 corrects the selected transformed image data based on the positional deviation between the object appearing in the master image data and the object appearing in the selected transformed image data (S306).

A numerical value indicated by the pointer of the meter is read from the corrected transformed image data (S307).

As described above, the operation of the image processing device 30 according to the third present example embodiment ends.

### Effects of Present Example Embodiment

According to the configuration of the present example embodiment, the generation unit 11 generates a transformed image group including a plurality of pieces of transformed image data by performing affine transformation on target image data. The calculation unit 12 calculates a correlation value between the transformed image data included in the transformed image group and the master image data registered in advance. The selection unit 13 selects the transformed image data having the maximum correlation value from the transformed image data included in the transformed image group. The correction unit 14 corrects the selected transformed image data based on the positional deviation between the object appearing in the master image data and the object appearing in the selected transformed image data.

In this manner, one piece of the transformed image data is selected from the transformed image group generated from the target image data based on the magnitude of the correlation with the master image data. The transformed image data having the largest correlation value with the master image data is closest to the master image data in terms of the angle of the imaging device with respect to the meter and the distance from the imaging device to the meter. By selecting the transformed image data having a high correlation value with the master image data, the accuracy of correcting the target image data using the master image data can be improved.

Furthermore, according to the configuration of the present example embodiment, the reading unit 25 reads the numerical value indicated by the pointer of the meter from the corrected transformed image data. As a result, it is possible to reduce the work load of the user related to the management of the meter and to reduce the work cost.

Furthermore, according to the configuration of the present example embodiment, the detection unit 36 detects the two-dimensional barcode from the target image data. The pre-correction unit 37 pre-corrects the target image data by affine transformation or homography transformation based on the two-dimensional shape of the two-dimensional barcode. As a result, the shape and size of the target in the pre-corrected target image data approach the shape and size of the target in the master image data. Therefore, the target image data can be corrected accurately, compared with that in the case where the pre-correction is not performed.

(Hardware Configuration)

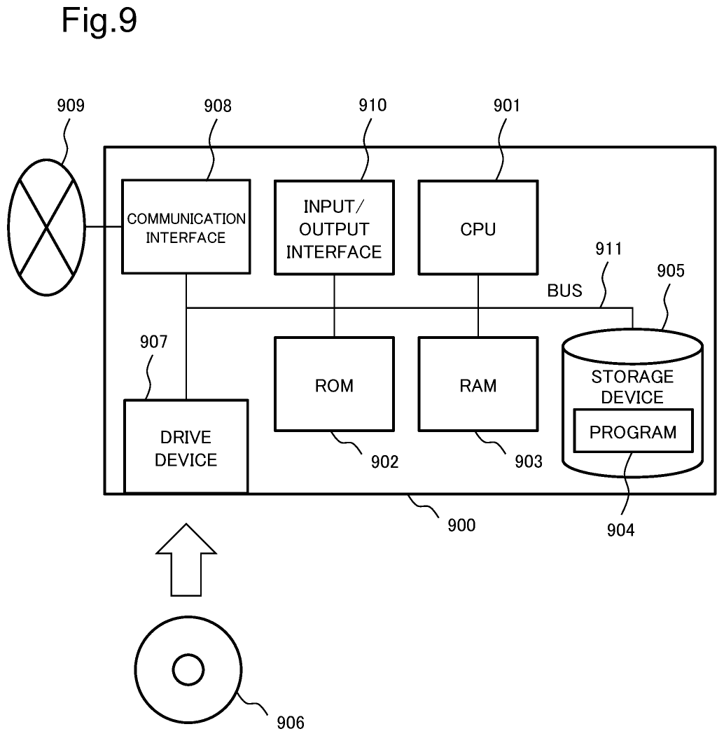

Each component of the image processing devices 10, 20, and 30 described in the first to third example embodiments indicates a block of a functional unit. Some or all of these components are implemented by an information processing device 900 as illustrated in FIG. 9, for example. FIG. 9 is a block diagram illustrating an example of a hardware configuration of the information processing device 900.

As illustrated in FIG. 9, the information processing device 900 includes the following configuration as an example.
Central processing unit (CPU) 901
Read only memory (ROM) 902
Random access memory (RAM) 903
Program 904 loaded into the RAM 903
Storage device 905 that stores the program 904
Drive device 907 that reads and writes the recording medium 906
Communication interface 908 that is connected to a communication network 909
Input/output interface 910 that inputs and output data
Bus 911 that connects the components

The components of the image processing devices 10, 20, and 30 described in the first to third example embodiments are implemented by the CPU 901 reading and executing the program 904 that implements these functions. The program 904 for achieving the function of each component is stored in the storage device 905 or the ROM 902 in advance, for example, and the CPU 901 loads the program into the RAM 903 and executes the program as necessary. The program 904 may be supplied to the CPU 901 via the communication network 909, or may be stored in advance in the recording medium 906, and the drive device 907 may read the program and supply the program to the CPU 901.

According to the above configuration, the image processing devices 10, 20, and 30 described in the first to third example embodiments are achieved as hardware. Therefore, effects similar to the effects described in the above example embodiment can be obtained.

[Supplementary Notes]

Some or all of the above example embodiments may be described as the following Supplementary Notes, but are not limited to the following.

(Supplementary Note 1)

An image processing device including
a generation means configured to generate a transformed image group including a plurality of pieces of transformed image data by performing affine transformation on target image data,
a calculation means configured to calculate a correlation value between the transformed image data included in the transformed image group and master image data registered in advance,
a selection means configured to select transformed image data having the correlation value being maximum from among the transformed image data included in the transformed image group, and
a correction means configured to correct the selected transformed image data based on a positional deviation between an object appearing in the master image data and an object appearing in the selected transformed image data.

(Supplementary Note 2)

The image processing device according to Supplementary Note 1, wherein the generation means generate a predetermined number of pieces of transformed image data from a specific pattern region in the image data by a mapping combining enlargement, reduction, rotation, and translation.

(Supplementary Note 3)

The image processing device according to Supplementary Note 1 or 2, wherein
the generation means calculates the correlation value between a pixel value of a specific pattern region in the transformed image data and a pixel value of a related pattern region in the master image data.

(Supplementary Note 4)

The image processing device according to Supplementary Note 2 or 3, wherein
the pattern region is a region including a specific character or a specific number.

(Supplementary Note 5)

The image processing device according to any one of Supplementary Notes 1 to 4, wherein
the correction means performs projective transformation of the selected transformed image data in such a way that positional coordinates of an object in the master image data are related to positional coordinates of the object in the selected transformed image data.

(Supplementary Note 6)

The image processing device according to any one of Supplementary Notes 1 to 5, further including
a reading means configured to read a numerical value indicated by a pointer provided on an object from the corrected transformed image data.

(Supplementary Note 7)

The image processing device according to Supplementary Note 6, wherein
the generation means repeats generation of a predetermined number of pieces of transformed image data from the image data until a correlation value between at least one piece of transformed image data included in the transformed image group and master image data registered in advance exceeds a threshold value.

(Supplementary Note 8)

The image processing device according to any one of Supplementary Notes 1 to 7, further including
a detection means configured to detect a two-dimensional barcode from the target image data, and
a pre-correction means configured to pre-correct the target image data by performing the affine transformation or homography transformation, based on a two-dimensional shape of the two-dimensional barcode.

(Supplementary Note 9)

An image processing method including
generating a transformed image group including a plurality of pieces of transformed image data by performing affine transformation on target image data,
calculating a correlation value between an object appearing in the transformed image data included in the transformed image group and an object appearing in master image data registered in advance,
selecting transformed image data having the correlation value being maximum from among the transformed image data included in the transformed image group, and
correcting the selected transformed image data based on a positional deviation between an object appearing in the master image data and an object appearing in the selected transformed image data.

(Supplementary Note 10)

A program for causing a computer to execute
a step of generating a transformed image group including a plurality of pieces of transformed image data by performing affine transformation on target image data,
a step of calculating a correlation value between the transformed image data included in the transformed image group and master image data registered in advance,
a step of selecting transformed image data having the correlation value being maximum from among the transformed image data included in the transformed image group, and
a step of correcting the selected transformed image data based on a positional deviation between an object appearing in the master image data and an object appearing in the selected transformed image data.

(Supplementary Note 11)

The image processing device according to any one of Supplementary Notes 1 to 6, wherein
the generation means repeats generation of a predetermined number of pieces of transformed image data from the image data until a numerical value indicated by a pointer of an object is successfully read from the corrected transformed image data.

(Supplementary Note 12)

The image processing device according to Supplementary Note 8, wherein
the generation means generates the transformed image group including the plurality of pieces of transformed image data by performing affine transformation on the pre-corrected image data.

Although the present invention is described with reference to the example embodiments (and examples), the present invention is not limited to the above example embodiments (and examples). Various modifications that can be understood by those of ordinary skill can be made to the configurations and details of the above example embodiments (and examples) within the scope of the present invention.

This application claims priority based on Japanese Patent Application No. 2021 028035 filed on Feb. 25, 2021, the entire disclosure of which is incorporated herein. Industrial Applicability

The present invention can be used, for example, in an image processing device that reads a numerical value indicated by a pointer of an analog meter from image data obtained by imaging the analog meter.

### REFERENCE SIGNS LIST

10 image processing device
11 generation unit
12 calculation unit
13 selection unit
14 correction unit
20 image processing device
25 reading unit
30 image processing device
36 detection unit
37 pre-correction unit

What is claimed is:

1. An image processing device comprising:
a memory configured to store instructions; and
at least one processor configured to perform the instructions to execute:
generating a transformed image group including a plurality of pieces of transformed image data by performing affine transformation on target image data;
calculating a correlation value between the transformed image data included in the transformed image group and master image data registered in advance;
selecting transformed image data having the correlation value being maximum from among the transformed image data included in the transformed image group; and
correcting the selected transformed image data based on a positional deviation between an object appearing in the master image data and an object appearing in the selected transformed image data.

2. The image processing device according to claim 1, wherein
the at least one processor is configured to perform the instructions to execute:
generating a predetermined number of pieces of transformed image data from a specific pattern region in the image data by a mapping combining enlargement, reduction, rotation, and translation.

3. The image processing device according to claim 1, wherein
the at least one processor is configured to perform the instructions to execute:
calculating the correlation value between a pixel value of a specific pattern region in the transformed image data and a pixel value of a related pattern region in the master image data.

4. The image processing device according to claim 2, wherein
the pattern region is a region including a specific character or a specific number.

5. The image processing device according to claim 1, wherein
the at least one processor is configured to perform the instructions to execute:
performing projective transformation of the selected transformed image data in such a way that positional coordinates of an object in the master image data are related to positional coordinates of the object in the selected transformed image data.

6. The image processing device according to claim 1, wherein
the at least one processor is further configured to perform the instructions to execute:
reading a numerical value indicated by a pointer of an object from the corrected transformed image data.

7. The image processing device according to claim 6, wherein
the at least one processor is configured to perform the instructions to execute:
repeating generation of a predetermined number of pieces of transformed image data from the image data until a correlation value between at least one piece of transformed image data included in the transformed image group and master image data registered in advance exceeds a threshold value.

8. The image processing device according to claim 1, wherein:
the at least one processor is further configured to perform the instructions to execute:
detecting a two-dimensional barcode from the target image data; and
pre-correcting the target image data before performing the affine transformation, based on a two-dimensional shape of the two-dimensional barcode.

9. The image processing device according to claim 1, wherein
the at least one processor is configured to perform the instructions to execute:
repeating generation of a predetermined number of pieces of transformed image data from the image data until a numerical value indicated by a pointer of an object is successfully read from the corrected transformed image data.

10. The image processing device according to claim 8, wherein
the at least one processor is configured to perform the instructions to execute:
generating the transformed image group including the plurality of pieces of transformed image data by performing affine transformation on the pre-corrected image data.

11. An image processing method comprising:
generating a transformed image group including a plurality of pieces of transformed image data by performing affine transformation on target image data;
calculating a correlation value between the transformed image data included in the transformed image group and master image data registered in advance;
selecting transformed image data having the correlation value being maximum from among the transformed image data included in the transformed image group; and
correcting the selected transformed image data based on a positional deviation between an object appearing in the master image data and an object appearing in the selected transformed image data.

12. A non-transitory recording medium storing a program for causing a computer to execute:
a step of generating a transformed image group including a plurality of pieces of transformed image data by performing affine transformation on target image data;
a step of calculating a correlation value between the transformed image data included in the transformed image group and master image data registered in advance;
a step of selecting transformed image data having the correlation value being maximum from among the transformed image data included in the transformed image group; and
a step of correcting the selected transformed image data based on a positional deviation between an object appearing in the master image data and an object appearing in the selected transformed image data.
